(19) United States
(12) Patent Application Publication
(10) Pub. No.: US 2025/0110812 A1
(43) Pub. Date: Apr. 3, 2025

(54) TECHNOLOGIES TO STORE COMPRESSED DATA

(71) Applicant: Intel Corporation, Santa Clara, CA (US)

(72) Inventors: Yingqi LU, Portland, OR (US); Smita KUMAR, Chandler, AZ (US); Tracy Garrett DRYSDALE, Paradise Valley, AZ (US); Ranjit MENON, Portland, OR (US); Toby OPFERMAN, Portland, OR (US); Deepak GANDIGA SHIVAKUMAR, Beaverton, OR (US); Stephen DOYLE, Ennis (IE); Corey D. GOUGH, Portland, OR (US)

(21) Appl. No.: 18/979,399

(22) Filed: Dec. 12, 2024

(51) Int. Cl. G06F 9/54

(52) U.S. Cl. CPC G06F 9/544

(57) ABSTRACT

Examples described herein relate to a processor to execute the instructions to cause: issue a first call to an application program interface (API) to an accelerator to cause the accelerator to compress data. In some examples, the API is to indicate whether the data is to be preserved in a buffer. In some examples, the API is to indicate a first offset. In some examples, the accelerator is to store the data starting at an address that is the first offset from a beginning address of the buffer allocated in a memory device. In some examples, the accelerator is to store the compressed data starting at a second offset from the beginning address of the buffer while the data is also stored in the buffer.

In computing platforms, central processing units (CPUs) can offload certain operations to accelerator devices (e.g., field programmable gate arrays (FPGAs)) in order to free-up CPU cycles for other operations and accelerate the performance of the offloaded operations. For example, a CPU can offload operations to accelerator devices to perform cryptography, graphics processing, and/or compression.

### BRIEF DESCRIPTION OF THE DRAWINGS

FIG. 1 depicts an example system.

FIG. 2 depicts an example system.

FIG. 3 depicts an example of recovery of data.

FIG. 4 depicts an example process.

FIG. 5 depicts an example computing system.

### DETAILED DESCRIPTION

Some accelerator devices perform compression operations offloaded from a processor. The accelerator device reads the data to be compressed from a source buffer and writes the compressed data to a different destination buffer. An operating system (OS) allocating both source and destination buffers as physically contiguous addresses in a memory pool for compression operations can reduce available system resources and reduce performance of the system.

Various examples allocate a buffer to store both compressed input and output data, such as input data prior to compression and compressed output data. Uncompressed input data can be stored in the buffer at an offset from a start of the buffer and a compressed data can be written starting at a second offset from the start of the buffer. In some examples, the second offset is zero and the compressed data starts from the beginning of the buffer. If the offset of the uncompressed content can be set to be large enough so that compressed content may not overwrite the uncompressed content before the uncompressed content is compressed. If a requester of the compression (e.g., application) has maintained a copy of the uncompressed data and does not restore the uncompressed content from the buffer if compression fails, the offset can be set to ceil

$$( \frac{M}{B} ) * 5 ( bytes ) + 4 KB ,$$

however other examples of offset values can be used. The offset can be ceil (M/B)*5 (bytes)+B+4 KB when the requester does not maintain a copy of the uncompressed original data and is to restore the original data in case of failure to compress original data. The ceil function can map a real number (M/B) to the least integer greater than or equal to (M/B).

Various examples can potentially reduce physically contiguous memory allocation by an operating system (OS) kernel or driver for compression of data. Various examples can reduce memory fragmentation. In addition, various examples can potentially improve accelerator performance and reduce memory bandwidth utilization.

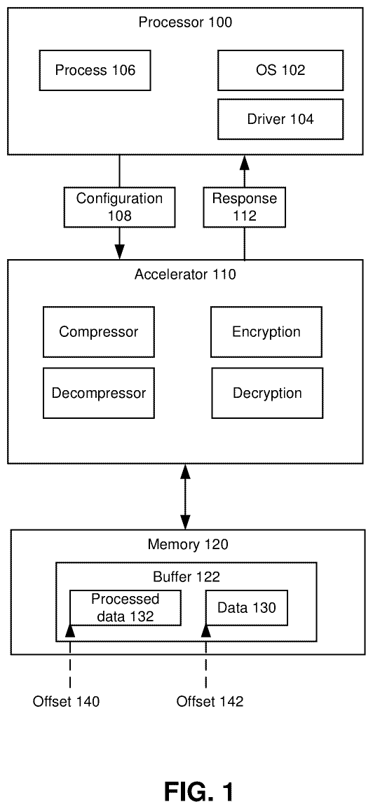

FIG. 1 depicts an example system. Processor 100 can include one or more of: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry. A processor core can include an execution core or computational engine that is capable of executing instructions. A core can access to its own cache and read only memory (ROM), or multiple cores can share a cache or ROM. Cores can be homogeneous (e.g., same processing capabilities) and/or heterogeneous devices (e.g., different processing capabilities). A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

Processor 100 can execute a process of processes 106 that requests compression, decompression, encryption, or decryption operations to be performed by accelerator 110. Processes 106 can include one or more of: application, process, thread, a virtual machine (VM), microVM, container, microservice, or other virtualized execution environment. Processor-executed operating system (OS) 102 or driver 104 can cause accelerator circuitry 110 to perform the operations based on calls by a process to an Application Programming Interface (API), as described herein.

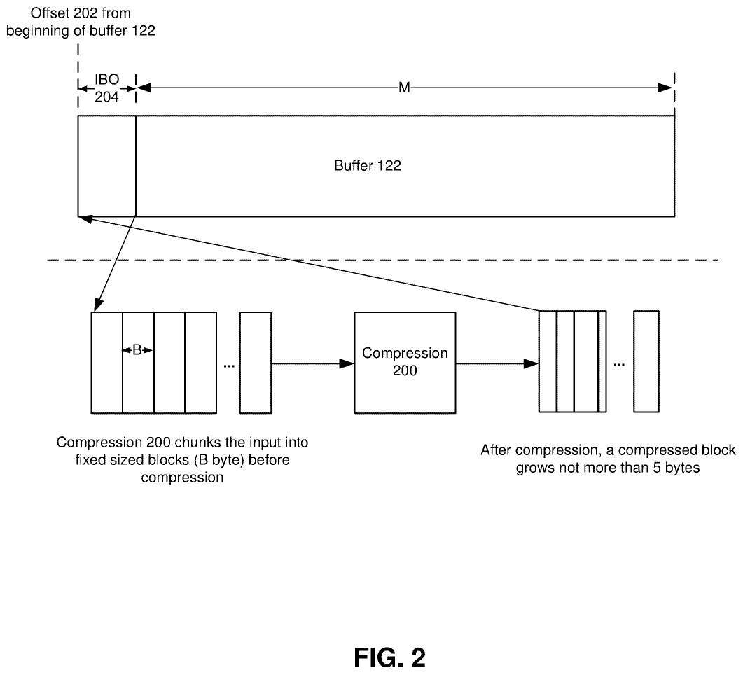

Accelerator circuitry 110 can perform operations offloaded from processor 100. For example, accelerator circuitry 110 can perform one or more of: compression, decompression, encryption, decryption, or others on data 130 stored in memory 120 based on configuration 108 from processor 100 (e.g., a process, OS, or driver) and provide processed data 132 (e.g., compressed data, decompressed data, encrypted data, or decrypted data) to memory buffer 122 of memory 120 or other device for storage. In some examples, buffer 122 can be allocated in a cache of accelerator 110. Processor 100, accelerator circuitry 110, and memory 120 can communicate based on communication standards or proprietary interfaces. In some examples, OS 102 or driver 104 can allocate memory buffer 122 as contiguous memory addresses in memory 120. In some examples, OS 102 or driver 104 can allocate starting memory addresses for data 130 and processed data 124 in memory 120 based on respective offsets 140 and 142 in configuration 108, as described herein, at least with respect to FIG. 2.

In some examples, accelerator circuitry 110 can be implemented as part of a network interface device, where a network interface device can include one or more of: a network interface controller (NIC), a remote direct memory access (RDMA)-enabled NIC, SmartNIC, router, switch, forwarding element, infrastructure processing unit (IPU), data processing unit (DPU), edge processing unit (EPU), or Amazon Web Services (AWS) Nitro Card. An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). A Nitro Card can include various circuitry to perform compression, decompression, encryption, or decryption operations as well as circuitry to perform input/output (I/O) operations.

In some examples, accelerator circuitry 110 can be implemented as part of a system-on-a-chip (SoC). Various examples of accelerator circuitry 110 can be implemented as a discrete device, in a die, in a chip, on a die or chip mounted to a circuit board, in a package, or between multiple packages, in a server, in a CPU socket, or among multiple servers. Processor 100 can access accelerator circuitry 110 or memory 120 by die-to-die communications; chipset-to-chipset communications; circuit board-to-circuit board communications; package-to-package communications; and/or server-to-server communications. Die-to-die communications can utilize Embedded Multi-Die Interconnect Bridge (EMIB) or an interposer. Components of FIG. 1 (e.g., processor 100, accelerator 110, or memory 120) can be enclosed in one or more semiconductor packages. A semiconductor package can include metal, plastic, glass, and/or ceramic casing that encompass and provide communications within or among one or more semiconductor devices or integrated circuits.

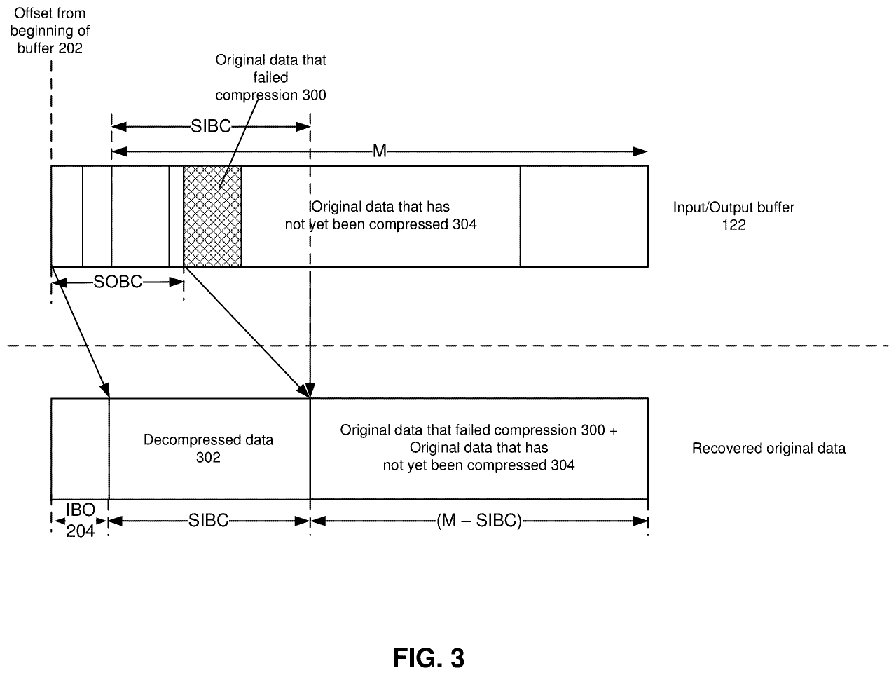

In some cases, a data compression operation on data can generate compressed data that, when decompressed by accelerator 110, does not generate the same data as that was compressed. Detection of such conditions can identify data that is not properly compressed and decompressed and identify potential corruption caused by hardware or system errors. After compression of a block of data 130, accelerator 110 can decompress the compressed block and determine if there is a mismatch between the decompressed block and the original data. As described herein, at least with respect to FIG. 3, based on a mismatch occurring, accelerator 110 can either restore original data to attempt to compress the data again by generating decompressed data from the compressed data block or issue an error feedback via response 112 to process 106. Based on successful compression of data, accelerator 110 can indicate a successful compression operation in response 112 to processor 100.

FIG. 2 depicts an example of storage of data and compressed data into a buffer. For example, uncompressed data can be split into multiple blocks of size B. To avoid a compression result overwriting uncompressed input before it is read by compression circuitry 200, a process (e.g., processes 106) can store uncompressed input data at a first offset 204 from the beginning of buffer 122 (e.g., region of contiguous or non-contiguous memory addresses) and compression circuitry 200 can store compressed results at a second offset 202 from the beginning of buffer 122. If the input buffer is offset by a first offset 204, the output data (e.g., compressed data) stored starting offset 202 may not overwrite the input uncompressed data before being processed by the accelerator.

In some examples, the first offset (e.g., input buffer offset (IBO) 204) can be:

$$Input Buffer Offset ( I B O ) = nearest integer that is greater than or equal to ( M / B ) * 5 + G$$

where:
M=input data size,
B=input data size M split into B sized blocks, and
G=guard band size (e.g., 4 KB or other sizes).

If the requester requests the ability of restoring the original buffer in case of compression failure, an additional block size (B) number of bytes can be added to the offset 204 if the compression circuitry checks compression errors at the block size granularity.

A compression format can add block headers to the uncompressed representations, which results in an expansion of compressed data size over original input data size. For example, compression formats Deflate, ZSTD and LZ4 formats can incur a 5 Bytes, 3 Bytes, or 4 Bytes overhead per block of input data. Based on a configuration (e.g., configuration 108), compression circuitry 200 can cause a maximum size of a compressed block to be equal to or less than B+N number of bytes, where N represents an amount of block header overhead.

After compression of data, compression circuitry 200 can perform inline verification, on a per-block basis, to verify that a decompressed version of the compressed data matches the data prior to compression. Based on a mismatch between a decompressed version of the compressed data and the original data, compression circuitry 200 can perform a recovery operation. During a recovery operation, compression circuitry 200 can provide an indication (e.g., response 112) of the number of uncompressed bytes that were successfully compressed (e.g., SIBC) and provide an indication of the data size of successfully compressed data (e.g., SOBC) corresponding to SIBC. If the verification is unsuccessful, an error code can be provided to the process, such as in response 112. If a process requests the original data to be recovered based on a failure to compress data, buffer 122 can be offset by an additional B number of bytes and compression circuitry 200 can recover data, as described herein, at least with respect to FIG. 3. For example, the requester can indicate restoring original data with a request to compress the original data so that the first offset (IBO 204) can be set correctly. After the compression starts, the first offset is not changed. The process can request compression circuitry 200 to reconstruct the original data from the buffer contents, such as if the process does not have an unmodified copy of the original uncompressed data in another buffer. The process can attempt to compress the original data or block of the original data again, after recovery of the original data. Compression circuitry 200 can indicate buffer 122 is corrupted to a process based on multiple errors arising from decompressing the compressed data to indicate original data is not recoverable, such as in response 112.

While examples are described with respect to compression of data, examples can apply to encryption, decryption, decompression, or other processing of data, such as processing or modification of headers of a packet.

FIG. 3 depicts an example of recovery of compressed data. Based on a process requesting recovery of data in an event of compression failure or error to compress region 300, compression circuitry can recover original data from compressed data and store original data that failed compression 300 and original data that has not been compressed 304 into the same buffer that stores compressed and original data. To recover the original data from compressed data, the compression circuitry can decompress SOBC number of bytes in input/output buffer 122 from offset 202, and perform a memory copy operation of (M-SIBC) number of bytes in input/output buffer 122 starting an offset of IBO+SIBC bytes. Compression circuitry can perform a memory copy of the original data that failed compression 300 and original data that has not been compressed 304 to buffer 122 starting at IBO+SIBC from offset 202. Accordingly, original data can be restored in buffer 122 as decompressed data 302, original data that failed compression 300, and original data that has not been compressed 304.

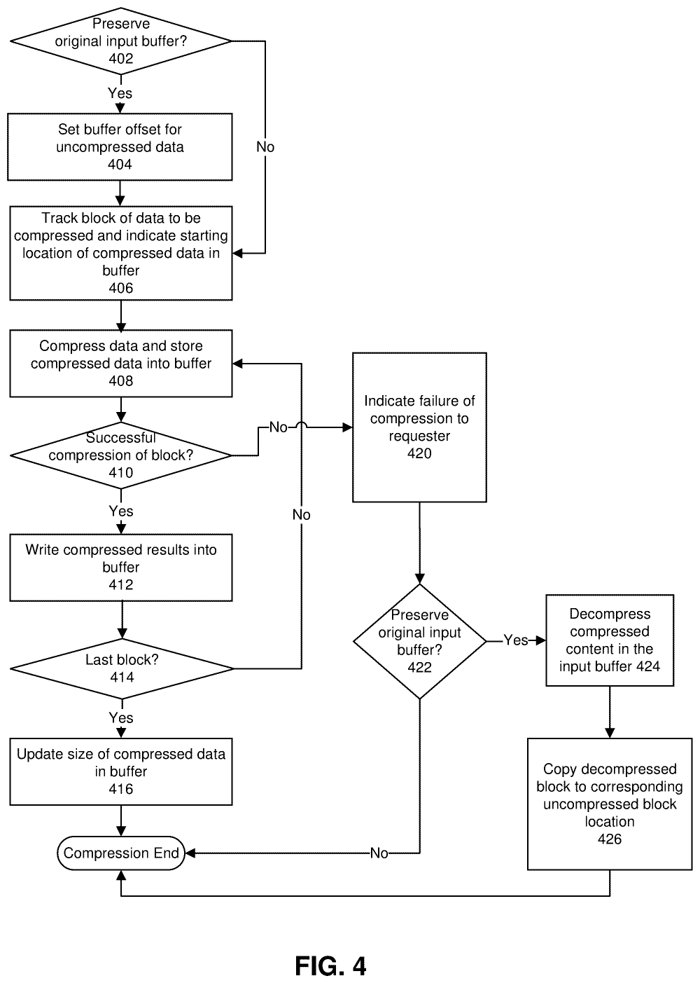

FIG. 4 depicts an example process. The process can be performed by an accelerator or processor-executed process, in some examples. At 402, a determination can be made as to whether there is a request to not overwrite data that is to be compressed in a buffer. Based on not overwriting data that is to be compressed, at 404, an additional offset from a beginning of a buffer for storage of uncompressed data, as described herein, can be set so that compressed data may not overwrite data that is compressed in a buffer. If restoration of original data is not needed, an offset is applied that is B bytes less than the case when the requester needs to restore the original data, as described herein. The process can proceed to 406.

Based on the allowing overwriting of data that is to be compressed in a buffer, at 406, a storage location of a data block and a data block identifier can be set. For example, a compression output offset can be set to 0 and a current block identifier can be set to 0. At 408, the data block can be compressed and compressed data stored in the buffer at the specified offset. For example, compression input offset from a beginning of a buffer can be tracked as B*current block identifier+IBO.

At 410, a determination can be made if the block of data was compressed successfully by decompressing the compressed data block and comparing it to the block of uncompressed data. If the decompressed data block matches the uncompressed data, then the data was compressed successfully. If the decompressed data block does not match the uncompressed data, then the data was not compressed successfully.

Based on the data block being successfully compressed, the process can proceed to 412, to store the compressed data in the buffer. In addition, current block identifier counter can be incremented, and compression output offset can be increased by compressed block size.

At 414, a determination can be made as to whether a last block of uncompressed data has been compressed. Based on the data block being the last block that was compressed, the process can proceed to 416. At 416, a size of compressed data in the buffer can be stored and successful compression can be indicated to a requester (e.g., process or application). Based on the data block not being the last block that was compressed, the process can proceed to 408 to compress a next block of uncompressed data.

Returning to 410, based on the data block not being successfully compressed, the process can proceed to 420. At 420, the compression circuitry can provide an error code to a requester of compression to indicate compression has failed. At 422, a determination can be made as to whether the original data that was compressed is to be restored based on a failure to compress data. Based on the original data that was compressed is to be restored based on a failure to compress data, the process can proceed to 424. Based on the original data that was compressed is not to be restored based on a failure to compress data, the process can end or perform other operations or actions.

At 424, compressed data can be decompressed to restore data. For example, a compressed blocks of data that was successfully compressed can be decompressed to restore blocks of data. At 426, the decompressed data can be written to an original address span of the original data. For example, if compressed blocks of data were successfully compressed, the compressed blocks of data can be decompressed and stored in a range offset by IBO from a beginning of the buffer and span SIBC number of bytes.

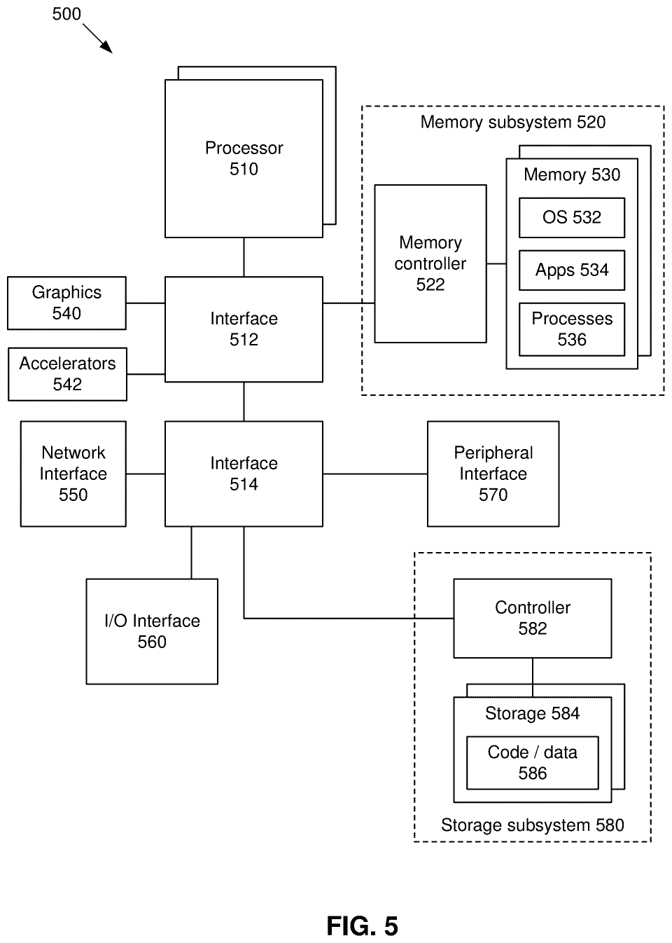

FIG. 5 depicts a system. The system can use examples to compress data and store the compressed data in a same buffer that stores the data and recover the data based on errors in data compression, as described herein. In some examples, processor 510, graphics 540, one or more of accelerators 542, and/or network interface 550 can decompress or decrypt data and store an entirety of decompressed or decrypted data or a strict subset of decompressed or decrypted data or validate decompression or decryption operations, described herein. System 500 includes processor 510, which provides processing, operation management, and execution of instructions for system 500. Processor 510 can include any type of microprocessor, central processing unit (CPU), graphics processing unit (GPU), processing core, or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die.

Accelerators 542 can be a fixed function or programmable offload engine that can be accessed or used by a processor 510. For example, an accelerator among accelerators 542 can provide data compression (DC) capability, cryptography services such as public key encryption (PKE), cipher, hash/authentication capabilities, decryption, or other capabilities or services. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 542 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as static random-access memory (SRAM), dynamic random-access memory (DRAM), or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

In some examples, OS 532 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

In some examples, OS 532 or driver can advertise capability of at least one of accelerators 542 to perform compression of data and store the compressed data in a buffer that stores the data but offset from the data, as described herein. In some examples, OS 532 or driver can enable or disable use at least one of accelerators 542 to perform compression of data and store the compressed data in a buffer that stores the data but offset from the data.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. In some examples, network interface 550 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory.

Some examples of network interface 550 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 550 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONIC), Broadcom® Network Programming Language (NPL), NVIDIA® CUDAR, NVIDIA® DOCA™ Data Plane Development Kit (DPDK), OpenDataPlane (ODP), Infrastructure Programmer Development Kit (IPDK), x86 compatible executable binaries or other executable binaries, or others.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory is memory whose state (and therefore the data stored in it) is indeterminate if power is interrupted to the device. A non-volatile memory (NVM) device is a memory whose state is determinate even if power is interrupted to the device.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chipset-to-chipset communications, die-to-die communications, packet-based communications, communications over a device interface (e.g., PCIe, CXL, UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes at least one non-transitory computer-readable medium comprising instructions, that if executed by one or more processors, cause the one or more processors to: receive a first call from an application programming interface (API) to cause an accelerator to compress data, wherein: the API is to indicate whether the data is to be preserved in a buffer, the API is to indicate a first offset, the accelerator is to store the data starting at an address that is the first offset from a beginning address of the buffer allocated in a memory device, and the accelerator is to store the compressed data starting at a second offset from the beginning address of the buffer while the data is also stored in the buffer.

Example 2 includes one or more examples, wherein a value of the first offset is based on one or more of: size of the data, padding associated with data compression, or block size of the data that is to be compressed.

Example 3 includes one or more examples, wherein: based on a request to the accelerator to preserve the data in the buffer, the accelerator is to check for an error in data compression and based on the error in a block of the compressed data, restore data corresponding to the block into the buffer.

Example 4 includes one or more examples, wherein to restore data corresponding to the block into the buffer, the accelerator is to copy decompressed data to an offset from the beginning address of the buffer.

Example 5 includes one or more examples, wherein the accelerator is to check for an error in compression of the data and based on the error in a block of the compressed data, the accelerator is to decompress a portion of the data that was overwritten by compressed data.

Example 6 includes one or more examples, wherein the accelerator is to indicate the buffer is corrupted based on one or more errors from decompression of the compressed data.

Example 7 includes one or more examples, wherein the API is to cause the accelerator to perform encryption of the data.

Example 8 includes one or more examples, and includes an apparatus that includes a memory to store instructions and a processor coupled to the memory, the processor to execute the instructions to cause: issue a first call to an application program interface (API) to an accelerator to cause the accelerator to compress data, wherein: the API is to indicate whether the data is to be preserved in a buffer, the API is to indicate a first offset, the accelerator is to store the data starting at an address that is the first offset from a beginning address of the buffer allocated in a memory device, and the accelerator is to store the compressed data starting at a second offset from the beginning address of the buffer while the data is also stored in the buffer.

Example 9 includes one or more examples, wherein: the accelerator comprises: an interface to a memory device and based on the API, circuitry to perform compression of the data and to store the compressed data starting at the second offset from the beginning address of the buffer.

Example 10 includes one or more examples, wherein a value of the first offset is based on one or more of: size of the data, padding associated with data compression, or block size of the data that is to be compressed.

Example 11 includes one or more examples, wherein: based on a request to the accelerator to preserve the data in the buffer, the accelerator is to check for an error in data compression and based on the error in a block of the compressed data, restore data corresponding to the block into the buffer.

Example 12 includes one or more examples, wherein to restore data corresponding to the block into the buffer, the accelerator is to copy decompressed data to an offset from the beginning address of the buffer.

Example 13 includes one or more examples, wherein the accelerator is to check for an error in compression of the data and based on the error in a block of the compressed data, the accelerator is to decompress a portion of the data that was overwritten by compressed data.

Example 14 includes one or more examples, wherein the accelerator is to indicate the buffer is corrupted based on one or more errors from decompression of the compressed data.

Example 15 includes one or more examples, wherein the API is to cause the accelerator to perform encryption of the data.

Example 16 includes one or more examples, and includes a process of making an accelerator comprising: connecting an accelerator to a memory device, wherein the accelerator stores data starting at an address that is a first offset from a beginning address of a buffer allocated in the memory device, the accelerators compresses the data, and the accelerator stores the compressed data starting at a second offset from the beginning address of the buffer while the data is also stored in the buffer.

Example 17 includes one or more examples, wherein: the first offset is based on one or more of: size of the data, padding associated with data compression, or block size of the data that is to be compressed.

Example 18 includes one or more examples, wherein: based on a request to the accelerator to preserve the data in the buffer, the accelerator checks for an error in data compression and based on the error in a block of the compressed data, restores data corresponding to the block into the buffer.

Example 19 includes one or more examples, wherein: the accelerator indicates the buffer is corrupted based on one or more errors from decompression of the compressed data.

Example 20 includes one or more examples, wherein: the accelerator performs encryption of the data.

1. At least one non-transitory computer-readable medium comprising instructions, that if executed by one or more processors, cause the one or more processors to:
receive a first call from an application programming interface (API) to cause an accelerator to compress data, wherein:
the API is to indicate whether the data is to be preserved in a buffer,
the API is to indicate a first offset,
the accelerator is to store the data starting at an address that is the first offset from a beginning address of the buffer allocated in a memory device, and
the accelerator is to store the compressed data starting at a second offset from the beginning address of the buffer while the data is also stored in the buffer.

2. The computer-readable medium of claim 1, wherein a value of the first offset is based on one or more of: size of the data, padding associated with data compression, or block size of the data that is to be compressed.

3. The computer-readable medium of claim 1, wherein:
based on a request to the accelerator to preserve the data in the buffer, the accelerator is to check for an error in data compression and based on the error in a block of the compressed data, restore data corresponding to the block into the buffer.

4. The computer-readable medium of claim 3, wherein to restore data corresponding to the block into the buffer, the accelerator is to copy decompressed data to an offset from the beginning address of the buffer.

5. The computer-readable medium of claim 1, wherein the accelerator is to check for an error in compression of the data and based on the error in a block of the compressed data, the accelerator is to decompress a portion of the data that was overwritten by compressed data.

6. The computer-readable medium of claim 1, wherein the accelerator is to indicate the buffer is corrupted based on one or more errors from decompression of the compressed data.

7. The computer-readable medium of claim 1, wherein the API is to cause the accelerator to perform encryption of the data.

8. An apparatus comprising:
a memory to store instructions and
a processor coupled to the memory, the processor to execute the instructions to cause:
issue a first call to an application program interface (API) to an accelerator to cause the accelerator to compress data, wherein:
the API is to indicate whether the data is to be preserved in a buffer,
the API is to indicate a first offset,
the accelerator is to store the data starting at an address that is the first offset from a beginning address of the buffer allocated in a memory device, and
the accelerator is to store the compressed data starting at a second offset from the beginning address of the buffer while the data is also stored in the buffer.

9. The apparatus of claim 8, wherein:
the accelerator comprises:
an interface to a memory device and
based on the API, circuitry to perform compression of the data and to store the compressed data starting at the second offset from the beginning address of the buffer.

10. The apparatus of claim 8, wherein a value of the first offset is based on one or more of: size of the data, padding associated with data compression, or block size of the data that is to be compressed.

11. The apparatus of claim 8, wherein:
based on a request to the accelerator to preserve the data in the buffer, the accelerator is to check for an error in data compression and based on the error in a block of the compressed data, restore data corresponding to the block into the buffer.

12. The apparatus of claim 11, wherein to restore data corresponding to the block into the buffer, the accelerator is to copy decompressed data to an offset from the beginning address of the buffer.

13. The apparatus of claim 8, wherein the accelerator is to check for an error in compression of the data and based on the error in a block of the compressed data, the accelerator is to decompress a portion of the data that was overwritten by compressed data.

14. The apparatus of claim 8, wherein the accelerator is to indicate the buffer is corrupted based on one or more errors from decompression of the compressed data.

15. The apparatus of claim 8, wherein the API is to cause the accelerator to perform encryption of the data.

16. A process of making an accelerator comprising:
connecting an accelerator to a memory device, wherein the accelerator stores data starting at an address that is a first offset from a beginning address of a buffer allocated in the memory device, the accelerators compresses the data, and the accelerator stores the compressed data starting at a second offset from the beginning address of the buffer while the data is also stored in the buffer.

17. The process of claim 16, wherein:
the first offset is based on one or more of: size of the data, padding associated with data compression, or block size of the data that is to be compressed.

18. The process of claim 16, wherein:
based on a request to the accelerator to preserve the data in the buffer, the accelerator checks for an error in data compression and based on the error in a block of the compressed data, restores data corresponding to the block into the buffer.

19. The process of claim 16, wherein:
the accelerator indicates the buffer is corrupted based on one or more errors from decompression of the compressed data.

20. The process of claim 16, wherein:
the accelerator performs encryption of the data.
